(19) United States
(12) Patent Application Publication
(10) Pub. No.: US 2004/0227627 A1
(43) Pub. Date: Nov. 18, 2004

(54) Light emitting device for indicating statuses of a vehicle to other vehicles

(76) Inventor: Shih-Hsiung Li, Taipei (TW)

Correspondence Address: BIRCH STEWART KOLASCH & BIRCH, PO BOX 747, FALLS CHURCH, VA, 22040-0747, US

(21) Appl. No.: 10/436,135

(22) Filed: May 13, 2003

(51) Int. Cl. B60Q 1/50

(52) U.S. Cl. 340/464

(57) ABSTRACT

A light emitting device for indicating statuses of a vehicle to other vehicles, has an alarming light assembly that is controlled by a control unit, wherein the control unit detects the vehicle speed and where the vehicle has a brake action. Based on the detected vehicle speed, the control unit determines the color that the alarming light assembly emits to warn other drivers so that any possible collision is avoided. Further, if the vehicle breaks down, the alarming light assembly is formed as triangular frame and emits red light as a warning sign.

### BACKGROUND OF THE INVENTION

1. Field of Invention

The present invention relates to a light emitting device for indicating statuses of a vehicle to other vehicles, and more particularly to an indicating device that is able to vary the warning modes upon the vehicle speed to alarm other cars. Furthermore, the indicating device is able to be applied as a triangular warning device when the vehicle malfunctions on the road.

2. Related Art

For vehicle drivers, safe driving is an essential point for consideration on a highway. Conventionally, only the brake light of the vehicle is used as a warning sign for drivers behind to prevent any possible car collision. However, since the brake light is only activated when the driver brakes the car, the drivers behind may not have enough time to immediately respond with the possible result of a collision.

A light emitting device for indicating statuses of a vehicle to other vehicles in accordance with the present invention obviates or mitigates the aforementioned drawbacks.

### SUMMARY OF THE INVENTION

The main objective of the present invention is to provide an light emitting device for indicating statuses of a vehicle to other vehicles in response to the vehicle speed. Based on the vehicle speed, the light emitting device shows different colors to warn other drivers. Furthermore, the light emitting device is able to be formed as a triangular frame to be as a warning sign.

To achieve the objective, the present invention comprises:

a control unit to detect a speed of the vehicle and whether the vehicle has a brake action, and further to output driving signals based on the detected data;

an alarming light assembly in response to the driving signals of the control unit;

wherein the alarming light assembly is composed of three illuminating units each being made up of multiple light emitting diodes (LEDs) with different colors, whereby the three illuminating units emit different colors in response to the speed of the vehicle.

Other objectives, advantages and novel features of the invention will become more apparent from the following detailed description when taken in conjunction with the accompanying drawings.

### BRIEF DESCRIPTION OF THE DRAWINGS

FIG. 1 is a perspective view of a light emitting device of the present invention;

FIG. 2 is a perspective view of the light emitting device of FIG. 1 being folded as a triangular frame;

FIG. 3 is a block diagram of a control unit for the light emitting device in accordance with the present invention;

FIGS. 4A-4D are circuit diagrams of the control unit of FIG. 3;

FIG. 5 is an operation view showing the light emitting device is mounted on the rear windshield of a car;

FIGS. 6A-6F show the light emitting device displaying different modes in response to the different speeds of the vehicle; and

FIG. 7 is an operation view showing the light emitting device is formed as a triangular frame when the car has broken down.

### DETAILED DESCRIPTION OF THE INVENTION

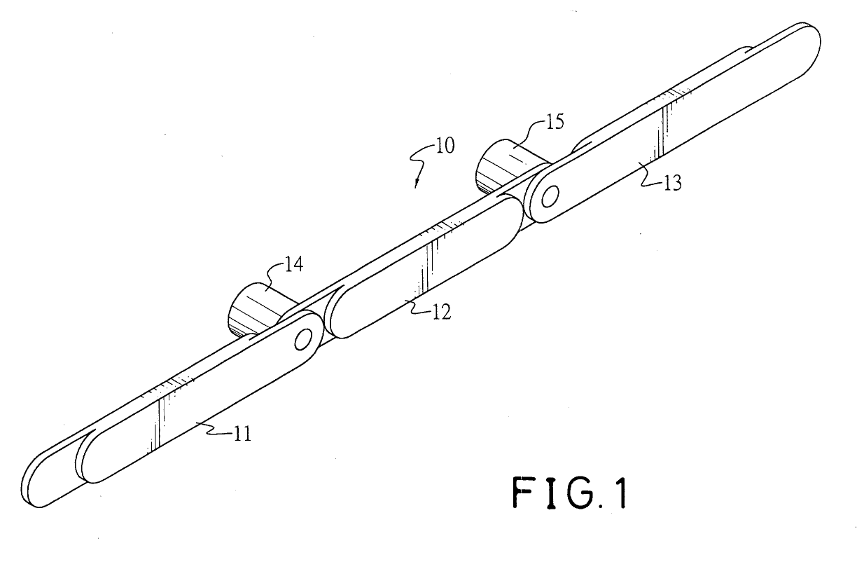

With reference to FIG. 1, a light emitting device is composed of an alarming light assembly (10) and a control unit (not shown in the figure).

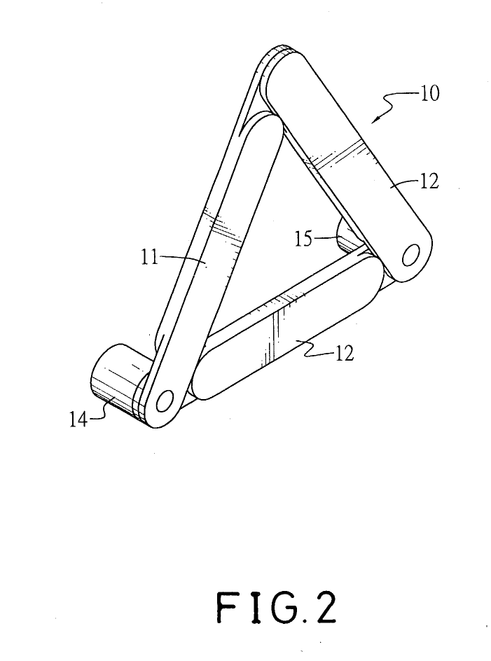

The alarming light assembly (10) is made up of three illuminating units (11-13), wherein each illuminating unit (11-13) can emit different colors upon the commands of the control unit to represent different speeds. The detailed operation and the color variations of the illuminating units (11-13) will be discussed later. The second illuminating unit (12) has two ends that respectively pivot with the first illuminating unit (11) and the third illuminating unit (13). Two stepping motors (14)(15) are respectively applied to control the pivot activation between the second illuminating unit (12) and the first illuminating unit (11), and between the second illuminating unit (12) and the third illuminating unit (13). By controlling the two stepping motors (14)(15), the first and second illuminating units (11)(13) can pivot with respect to the second illuminating unit (12) to form a triangular frame as shown in FIG. 2. Therefore, the driver of the vehicle can use the triangular frame as a warning device that emits red light when the car malfunctions etc.

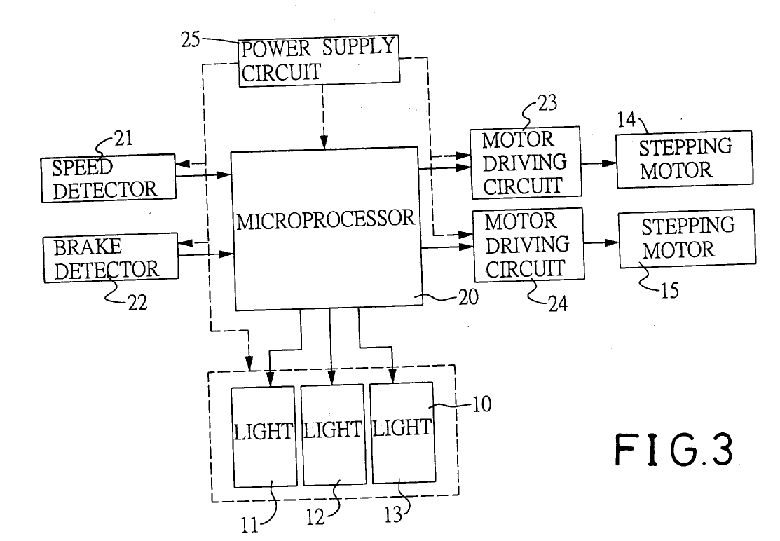

With reference to FIG. 3, the above mentioned control unit comprises a microprocessor (20), a speed detector (21), a brake detector (22), two motor driving circuits (23)(24) and a power supply circuit (25).

The microprocessor (20) has output terminals that correspondingly connect to and drive the three illuminating units (11-13).

The speed detector (21) has an output terminal connected to the microprocessor (20), whereby the detected vehicle speed is transmitted to the microprocessor (20).

The brake detector (22) has an output terminal connected to the microprocessor (20). In the event of any brake action, the brake detector (22) will output a signal to the microprocessor (20).

The two motor driving circuits (23)(24) respectively control and drive the two motors (14)(14) to rotate based on the commands from the microprocessor (20).

The power supply circuit (24) provides the DC operating voltage to the elements mentioned above.

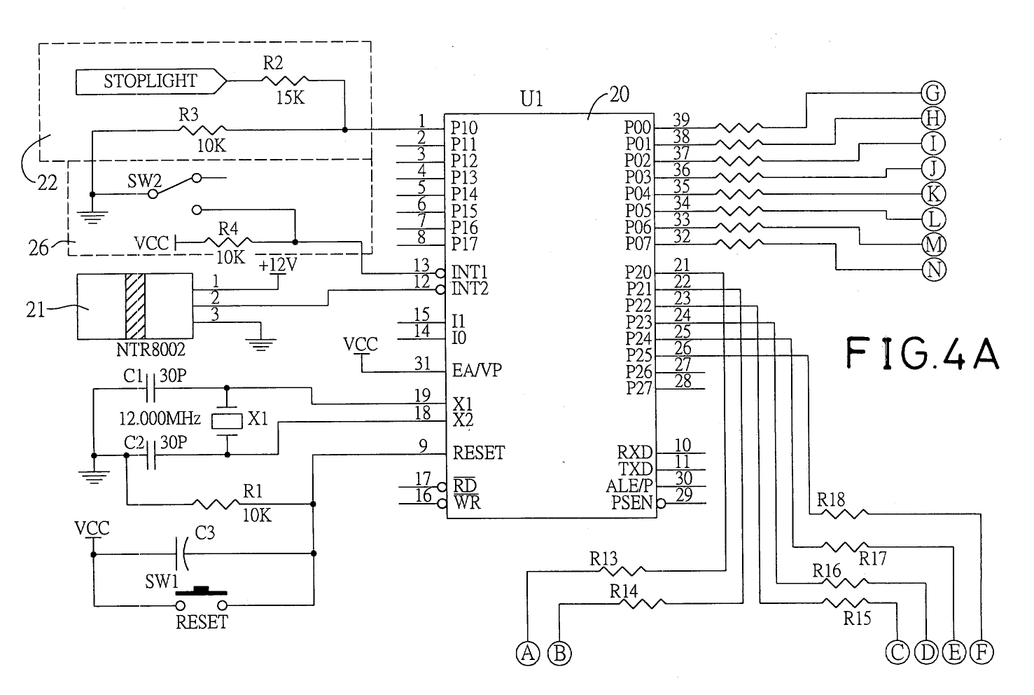

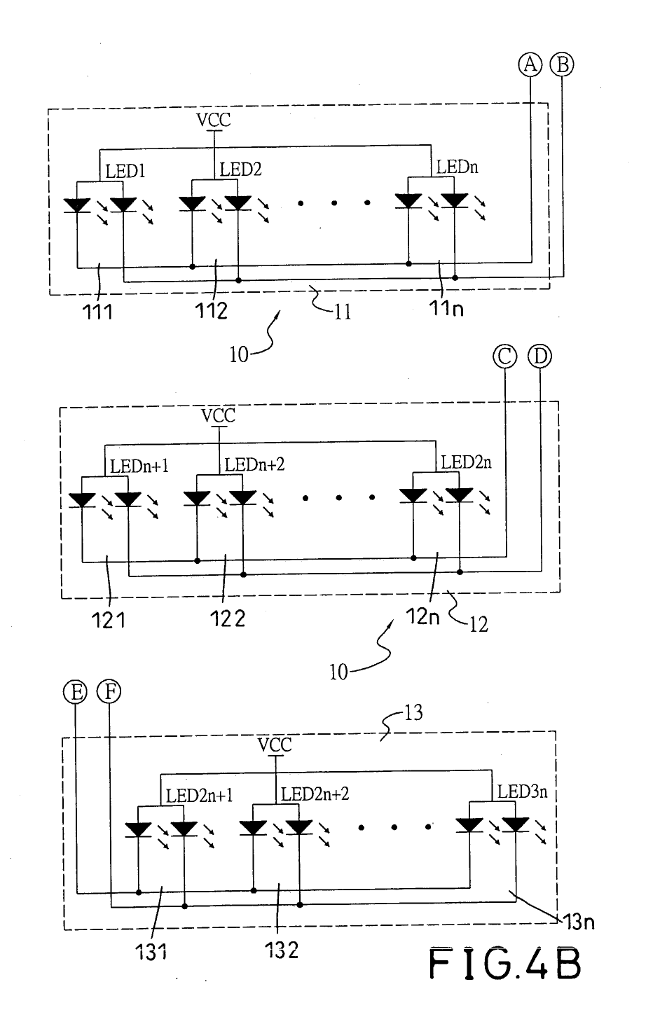

With reference to FIGS. 4A-4D, the detailed circuit of the control circuit is shown. The microprocessor (20) is chosen as an integrated circuit named AT89C51.

A failure switch (26) is connected to one input terminal of the microprocessor (20). In the condition that the vehicle malfunctions, the failure switch (26) is switched on by the driver, so the microprocessor (20) will control the two motor driving circuits (23)(24) to activate the two motors (14)(15).

The speed detector (21) is a Hall sensor and connects to one terminal (INT0) of the microprocessor (20). The speed detector (21) is provided to detect the rotation speed of the wheels, and then provides the number data and time parameters to the microprocessor (20) for speed calculation.

The brake detector (22) includes two resistors (R2)(R3) connected at a node in series, wherein the node is further connected to an input terminal (P10) of the microprocessor (20). The resistor (R2) with one end connects to a terminal from a stop light circuit (not shown). When the driver brakes the car, the stop light terminal outputs a high voltage level that is then divided by the two resistors (R2)(R3). Thus the microprocessor (20) can obtain a high voltage level and activate the alarming light assembly (10) to be used as a brake light. Otherwise, if there is no brake action, the voltage level of the input terminal (P10) of the microprocessor (20) is low. The alarming light assembly (10) still functions to display different modes in response to the vehicle speed.

The two motor driving circuits (23)(24) include multiple transistors (Q1-Q8) and diodes (D1-D8). The base terminal of each transistor (Q1-Q8) is connected to the microprocessor (20) through a photo coupler (O1-O8). Because the photo couplers (O1-O8) are applied for isolation between the motors (14)(15) and the microprocessor (20), the voltage level variations due to the motor activating are eliminated.

In the embodiment, each illuminating unit (11-13) is composed of multiple sets of light emitting diodes (LEDs) (111, 112-11n) (121, 122-12n) (131, 132-13n) with different colors. By properly determining the intensity of currents flowing through these LEDs (111, 112-11n) (121, 122-12n) (131, 132-13n), the illuminating units (11-13) can generate different colors by color mixing.

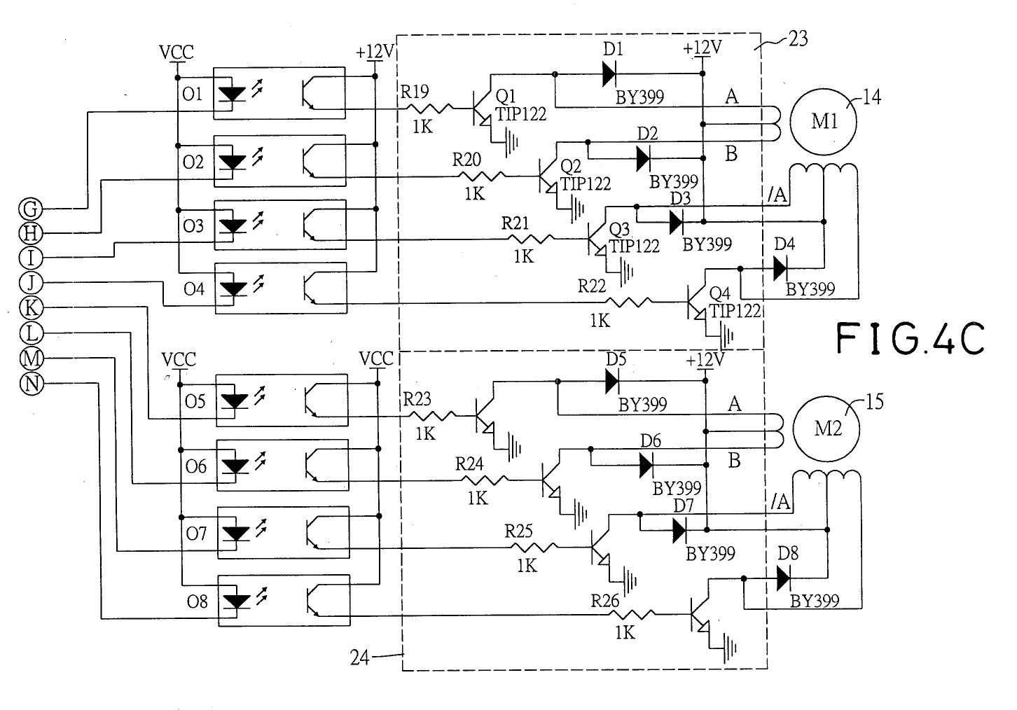

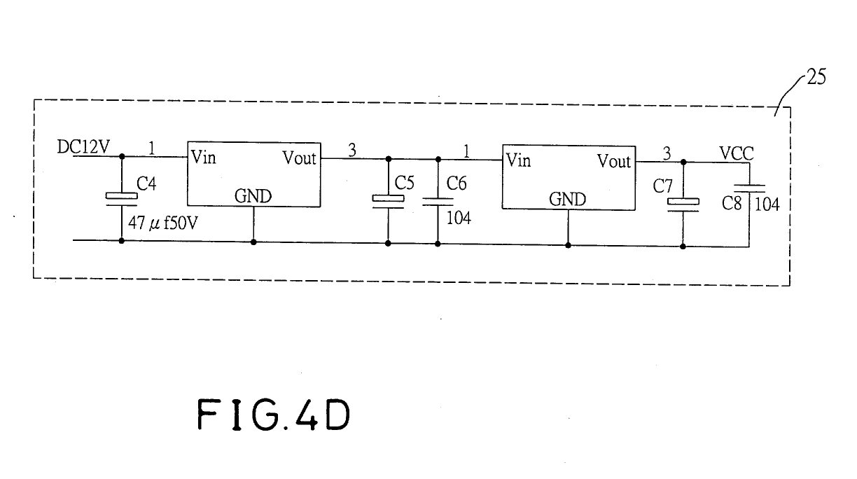

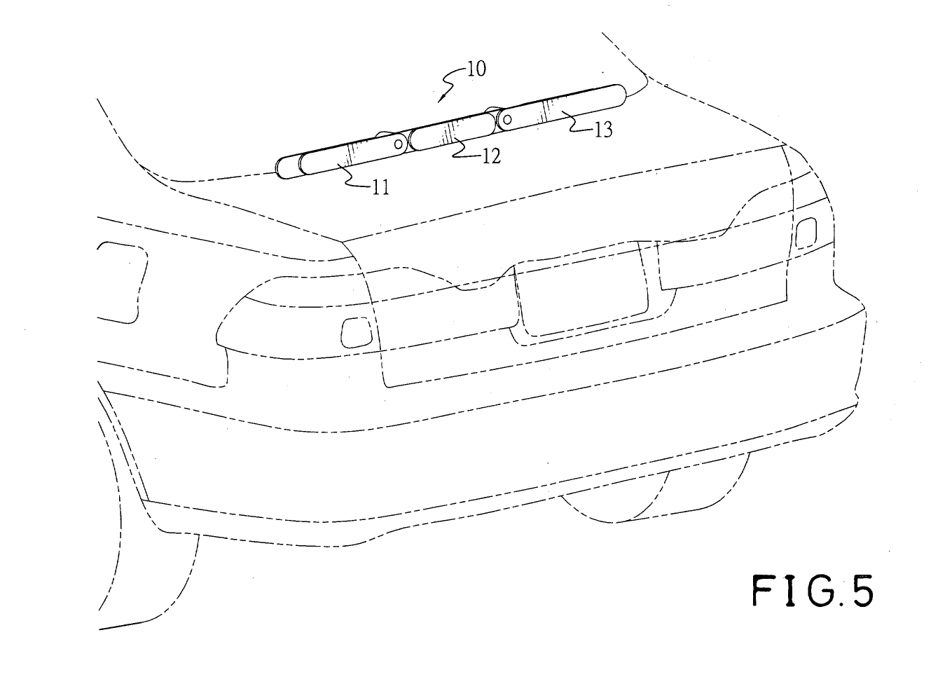

With reference to FIG. 5, when the alarming light assembly (10) is applied to a vehicle, it is mounted on the rear windshield. In the normal situation, the three illuminating units (11-13) of the alarming light assembly (10) are arranged as a straight-line.

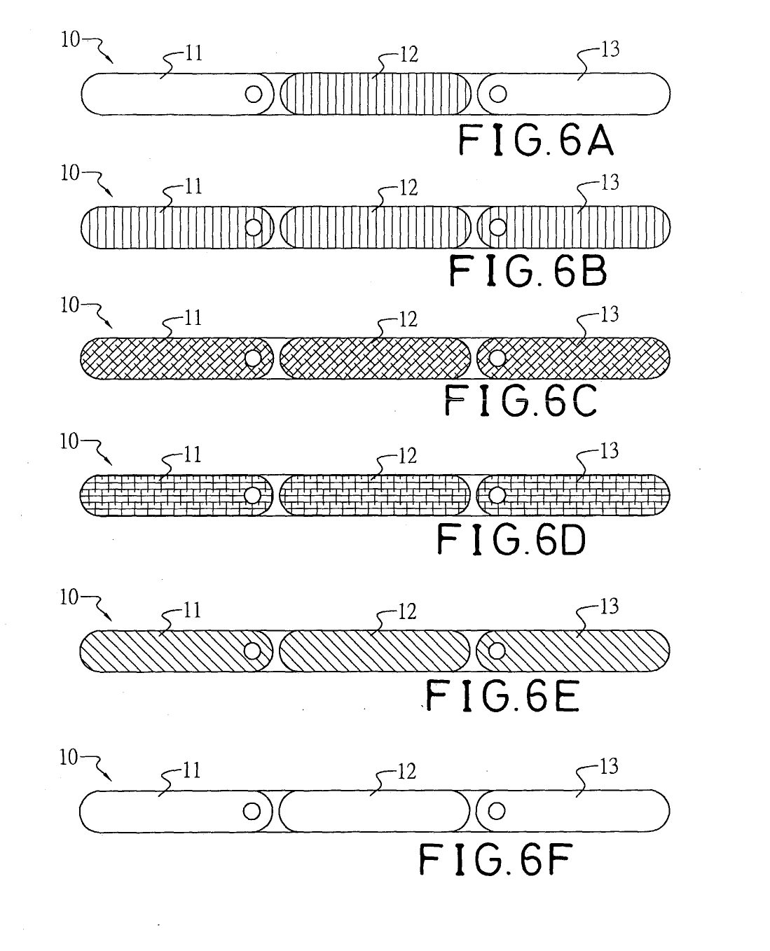

With reference to FIG. 6A, when the driver brakes the vehicle, the brake detector (22) receives a brake signal and outputs to the microprocessor (20). The microprocessor (20) only activates the second illuminating unit (12) with red light and the other two illuminating units (11)(13) are deactivated, so the alarming light assembly (10) is used as a brake light to warn other drivers behind the car.

With reference to FIGS. 6B-6F, the alarming light assembly (10) is operated with different modes to emit different colors in response to the vehicle's speed. The embodiment shows six modes.

1. With reference to FIG. 6B, when the vehicle's speed is between 0-30 kilometers (speed per hour), all three illuminating units (11-13) emit red light, which warns a vehicle behind the present vehicle that the present speed is low so as to prevent any collision.

2. With reference to FIG. 6C, when the vehicle speed is between 30-60 kilometers (speed per hour), all three illuminating units (11-13) emit orange light.

3. With reference to FIG. 6D, when the vehicle speed is between 60-90 kilometers (speed per hour), all three illuminating units (11-13) emit yellow light.

4. With reference to FIG. 6E, when the vehicle speed is between 90-120 kilometers (speed per hour), all three illuminating units (11-13) emit green light.

5. With reference to FIG. 6F, when the vehicle speed is over 120 kilometers (speed per hour), all three illuminating units (11-13) are deactivated.

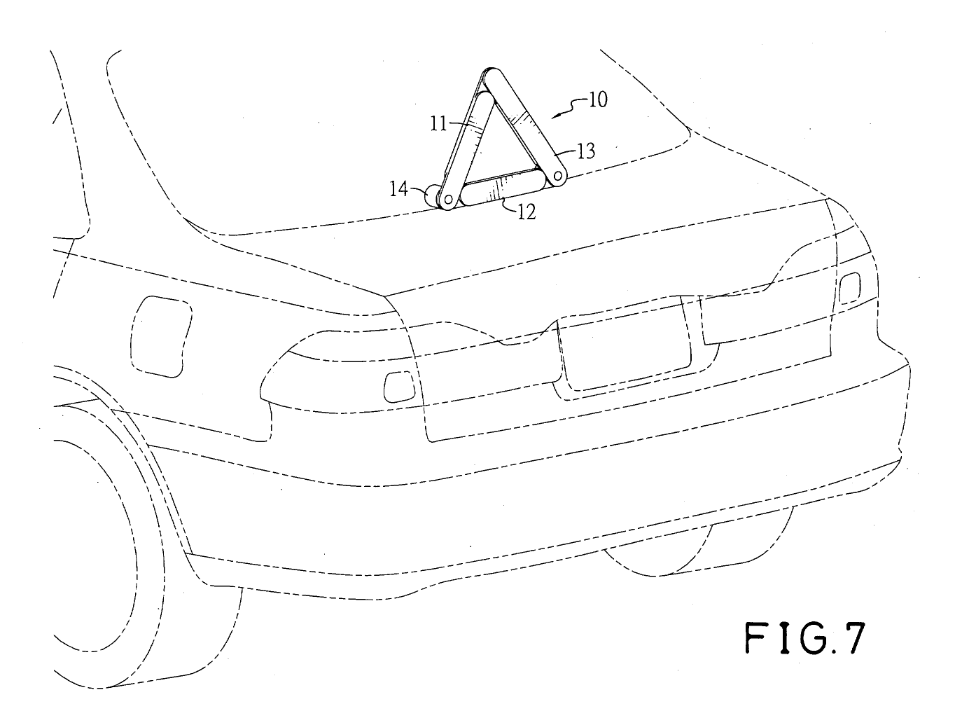

With reference to FIG. 7, in the event that the car breaks down on the road, the driver can use the failure switch (26) to activate the two stepping motors (14)(15). Therefore, the two illuminating units (11)(13) gradually rise to form a triangular frame. All illuminating units (11-13) will emit red light as a warning sign.

The invention may be varied in many ways by a skilled person in the art. Such variations are not to be regarded as a departure from the spirit and scope of the invention, and all such modifications are intended to be included within the scope of the following claims.

What is claimed is:

1. A light emitting device for indicating statuses of a vehicle to other vehicles, the light emitting device comprising:
a control unit to detect a speed of the vehicle and whether the vehicle has a brake action, and further to output driving signals based on the detected data;
an alarming light assembly in response to the driving signals of the control unit;
wherein the alarming light assembly is composed of three illuminating units to emit different color lights in response to the speed of the vehicle.

2. The light emitting device as claimed in claim 1, wherein one of the three illuminating units has two ends that respectively pivot with the other two illuminating units, wherein the other two illuminating units are respectively controlled by one of two stepping motors that are each driven by the control unit.

3. The light emitting device as claimed in claim 2, the control unit comprising:
a microprocessor with output terminals connected to the three illuminating units;
a speed detector connected to the microprocessor and providing a detected vehicle speed signal to the microprocessor;
a brake detector connected to the microprocessor and providing a detected brake signal to the microprocessor; and
two motor driving circuits controlled by the microprocessor, and respectively connected to and driving the two stepping motors.

4. The light emitting device as claimed in claim 3, wherein the speed detector is a Hall sensor that detects a rotation speed of the wheels of the vehicle, and then provides the rotation speed and time parameters to the microprocessor for vehicle speed calculation.

5. The light emitting device as claimed in claim 3, wherein the brake detector is composed of two resistors connected at node in series, wherein the node is further connected to an input terminal of the microprocessor, and one of the two resistors is adapted to connect to a stop light circuit to detect voltage level variation.

6. The light emitting device as claimed in claim 3, wherein each motor driving circuit is composed of multiple transistors and diodes.

7. The light emitting device as claimed in claim 6, wherein each transistor of the motor driving circuit has a base terminal connected to the microprocessor through a photo coupler.

8. The light emitting device as claimed in claim 3, wherein the control unit further has a failure switch connected to the microprocessor, when the failure switch is activated, the three illuminating units are driven by the two stepping motors to form a triangular frame as a warning sign.

9. The light emitting device as claimed in claim 1, wherein each of the three illuminating units is made up of multiple light emitting diodes (LEDs) with different colors.

10. The light emitting device as claimed in claim 3, wherein each of the three illuminating units is made up of multiple light emitting diodes (LEDs) with different colors.
